(19) United States
(12) Patent Application Publication
(10) Pub. No.: US 2026/0076349 A1
(43) Pub. Date: Mar. 19, 2026

(54) APPARATUS FOR SPEAR FISHING

(71) Applicant: Christopher Alvarez, North Palm Beach, FL (US)

(72) Inventor: Christopher Alvarez, North Palm Beach, FL (US)

(21) Appl. No.: 19/196,402

(22) Filed: May 1, 2025

Related U.S. Application Data
(60) Provisional application No. 63/641,246, filed on May 1, 2024.

(51) Int. Cl. A01K 81/04

(52) U.S. Cl. CPC A01K 81/04

(57) ABSTRACT

Spear fishing devices with handstraps are provided. In some embodiments, articles are provided that comprise handstraps extending up to a front end of a shaft handle, allowing users to pinch the shaft. Further, in some embodiments, a handstrap extending over a front end of a shaft is provided, offering users firm control and comfortable grabbing of a shaft. Further, in some embodiments, a spear fishing device comprises a detachable shooter, which will remain on users'hands after launching a projectile toward targets. The detachable shooter feature increases the projectile's traveling distance and aiming accuracy.

### CROSS-REFERENCE TO RELATED APPLICATIONS

This U.S. Non-Provisional Patent Application claims the benefit of priority from U.S. Provisional Patent Application Ser. No. 63/641,246, filed on May 1, 2024, the entire disclosure of which is hereby incorporated by reference.

### FIELD

Embodiments of the present disclosure relate generally to hunting and fishing devices including, for example, spear fishing devices. Preferred embodiments of the present disclosure provide improved spear fishing devices that are operable to launch or project a spear under a stored force.

### BACKGROUND

Spear fishing has been a popular activity for fishing and diving hobbyists. A diving spear lets users launch or release a projectile under or above water. Two common types of spear fishing devices are known and are often referred to as Hawaiian slings and pole slings. Both Hawaiian slings and pole slings comprise a shaft, a spear tip, a shaft handler, and an elastic member for storing and releasing potential energy.

In general, a pole sling works better for inshore diving where users may not have a sufficient shooting range, and a Hawaiian sling has a better shooting range compared to a pole sling and is suitable for longer shot distances. Moreover, a pole sling has a shorter reload time, making catching small reef fish and fish in hiding nooks easier. On the other hand, because of its hydrodynamic shape, Hawaiian slings are easier to change out of the shafts depending on the fishing targets and easier to carry around in the water.

Some spear fishing devices comprise rail guns with one or more elastic members, a retention line, a trigger member, and/or a reel. Other devices comprise sling-style devices that are simpler in certain aspects of their operation and are often more user-friendly. Sling devices generally comprise a muzzle portion and an elastic member and wherein the device is devoid of a trigger and associated release mechanism. While sling devices are generally simpler to operate and provide fewer opportunities for broken parts, snared lined, and other mechanical complications, they generally lack a locking element to secure the spear in a ready-to-fire position. Accordingly, a user must generally secure the spear and maintain it in a loaded position under their own power, such as by grip force, often while swimming. Embodiments of the present disclosure generally relate to sling-style spear fishing devices. However, it should be recognized that inventive aspects and features of the present disclosure are not limited to any particular type of spearfishing gun or even to the sport of spearfishing.

Both the traditional Hawaiian slings and the pole slings have common disadvantages. Noticeably, the position of the elastic member is away from the shaft in conventional spearfishing devices, and users have found it difficult to control the direction and position of the shafts and tips in the water. With the unsecured shafts in conventional Hawaiian slings, it is also challenging for users to maneuver in the water, as they have to constantly avoid facing the shafts and tips downward. Many pole slings comprise an elastic member with a length and position that renders operation difficult. Pole slings often lack sufficient thrust force, especially when disturbed by strong water flow, resulting in insufficient shooting range and low accuracy.

Therefore, there is a long-felt yet unmet need for spear fishing devices that are versatile, easy to control, and maneuver under the water. Further, spear fishing devices with longer traveling distance has always been desired.

### SUMMARY

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification and claims are to be understood as being modified in all instances by the term “about”.

It is one aspect of the present disclosure to provide improved spear fishing devices. In various embodiments, an article is provided that comprises a tip, a shaft, a shaft handle with a front end proximate to the shaft and a back end opposite to the front end, and an elastic member, wherein the elastic member is connected to the shaft. In certain preferred embodiments, the article comprises a handstrap attached to the muzzle. In operation, spear fishing devices of the present disclosure are loaded by providing a spear in or in communications with the muzzle. A proximal end of the spear is provided in communication with the elastic member and the elastic member is stretched, storing potential energy in the elastic member. The handle is operable to assist a user in maintaining the potential energy and aiming the device until release of the same and associate firing of the spear is desired.

In various embodiments, a hand strap extends from and is secured to the muzzle portion. Hand straps of the present disclosure preferably extend over a distal end of the muzzle and allow greater control of the device as will be shown and described herein.

In certain embodiments, a hand strap is wrapped around the muzzle, providing extra friction for users to grab the shaft. Muzzles of the present disclosure are contemplated as being formed of various materials including, but not limited to, wood, plastic, carbon fiber, and metal materials. Materials may be selected or varied to impact the weight, buoyancy, and frictional properties of the device.

One aspect of the present disclosure to provide versatile diving spears suitable for various and complex water conditions. Some embodiments of the present disclosure comprise a handstrap extending along at least a distal or forward portion of a device. Such arrangements allow users to grasp the muzzle and spear simultaneously and to ergonomically secure the spear in a loaded, ready-to-fire position.

In various embodiments of the present disclosures, spear fishing devices are provided that comprise a receiving portion for a proximal end of a spear. In preferred embodiments, the receiving portion is secured to the elastic member in a manner wherein the receiving portion is operable to transmit force from the elastic member to the spear. In some embodiments, the receiving portion comprises a cup or cradle that configured to receive a shaft of a spear, but not restrain or retard movement of the spear upon release.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S. C. § 112(f). Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

These and other advantages will be apparent from the disclosure of the invention(s) contained herein. The above-described embodiments, objectives, and configurations are neither complete nor exhaustive. The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

It is to be appreciated that any feature described herein can be claimed in combination with any other feature(s) as described herein, regardless of whether the features come from the same described embodiment.

Any one or more aspects described herein can be combined with any other one or more aspects described herein. Any one or more features described herein can be combined with any other one or more features described herein. Any one or more embodiments described herein can be combined with any other one or more embodiments described herein.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of the invention.

FIG. 1A illustrates a spear fishing device with a shaft, in accordance with one or more embodiments of the present disclosure;

FIG. 1B provides a detailed view of the spear fishing device of FIG. 1A with the shaft inserted into a receiving member of the spear fishing device;

FIG. 2A illustrates hand position at an initial state on the spear fishing device of FIG. 1A;

FIG. 2B provides another view of the hand position at the initial state on the spear finishing device of FIG. 1A;

FIG. 3 illustrates force distribution of the spear fishing device of FIG. 1A;

FIGS. 4A-4C illustrate a spear fishing device in accordance with one or more embodiments of the present disclosure;

FIG. 5 illustrates a spear fishing system in accordance with one or more embodiments of the present disclosure according to another embodiment of the present disclosure;

FIG. 6 illustrates a spear fishing device in accordance with one or more embodiments of the present disclosure;

FIG. 7A is a view of the spear fishing device of the embodiment of FIG. 3; and

FIG. 7B is a view of the spear fishing device of the embodiment of FIG. 3.

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

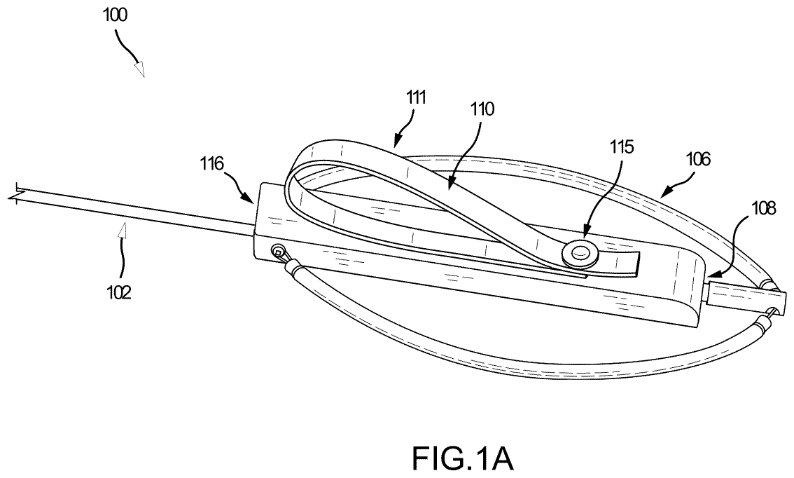

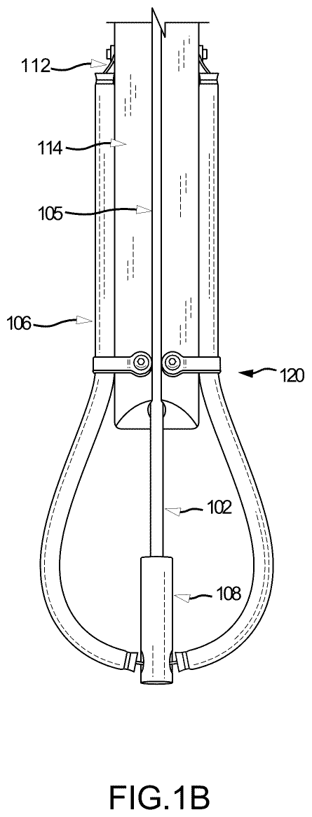

FIGS. 1A-1B illustrate an embodiment of a spear fishing device 100. The device 100 is shown in combination with a spear. The spear comprises a shaft 102 and is contemplated as being any one or more of existing, known spears. The spear 100 is contemplated as comprising the shaft 102 and a tip. The spear(s) for use with devices of the present disclosure may also comprise notched proximal ends, barbs, and other known features.

As further shown in FIGS. 1A-1B, the device 100 comprises a muzzle 114, an elastic member 106, and a hand strap 110. As shown, the muzzle 114 comprises an elongate member that is operable to be grasped by a user's hand. The muzzle 114 may vary in its dimensions, including length, diameter, and/or width. It is contemplated that the muzzle 114 is generally sized to be held and manipulated by a single human hand.

In certain embodiments, the elastic member 106 is secured to the muzzle 114 at a distal end thereof 116. In some embodiments, the elastic member 106 comprises two ends that are secured to opposing sides of the distal end of the muzzle 114. In other embodiments, the elastic member 106 comprises a continuous loop that passes through an aperture 112 in the distal end 116 of the muzzle 114. The elastic member 106 is sized and operable to extend beyond a proximal end of the muzzle.

As shown, first and second guide members 120 are provided to guide the elastic member 106 and maintain an alignment of the muzzle 114 and at least a portion of the elastic member 106. The proximal end of the elastic member 106 is contemplated as comprising a receiving member 108. The receiving member 108 is contemplated as comprising a void or recess operable to receive the distal end of the projectile 102. The receiving member 108 is contemplated as being sized and operable to impart a force to the end of the projectile 102.

The device 100 further comprises a hand strap 110. The hand strap 110 is secured to the muzzle 114 and preferably comprises a forward-facing loop 111. The hand strap 110 preferably comprises at least one anchor point 115 to secure the strap 110 to the muzzle, and further comprises a sufficient length to form a loop 111 that can receive a human hand and/or wrist. A second point of attachment is contemplated as being provided to, for example, prevent the strap 110 from rotating around a point created by the first anchor 115.

FIG. 1B depicts a lower or bottom portion of the device 100. As shown, an elongate slot 105 is contemplated as being provided along a bottom portion of the muzzle 114. The slot 105 is operable to provide a means for air or pressure release to ease insertion and/or release of a projectile, allows for expansion and contraction of the muzzle material (e.g. due to humidity and temperature changes), and reduces the weight of the device.

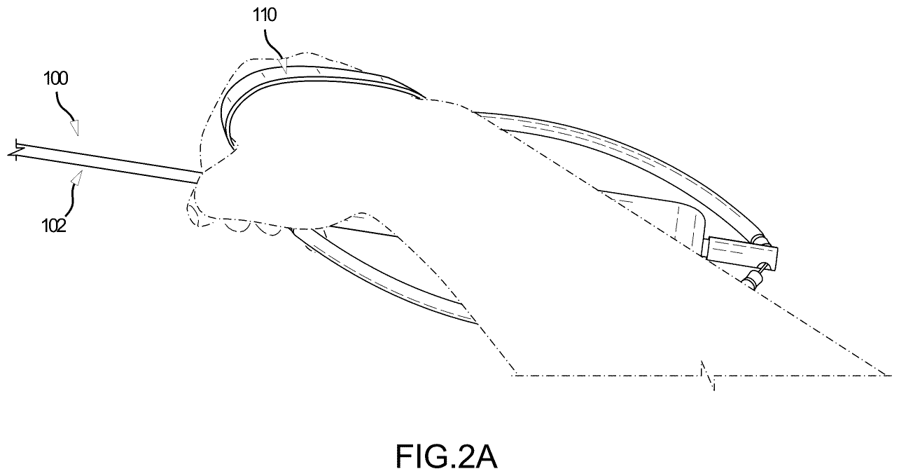

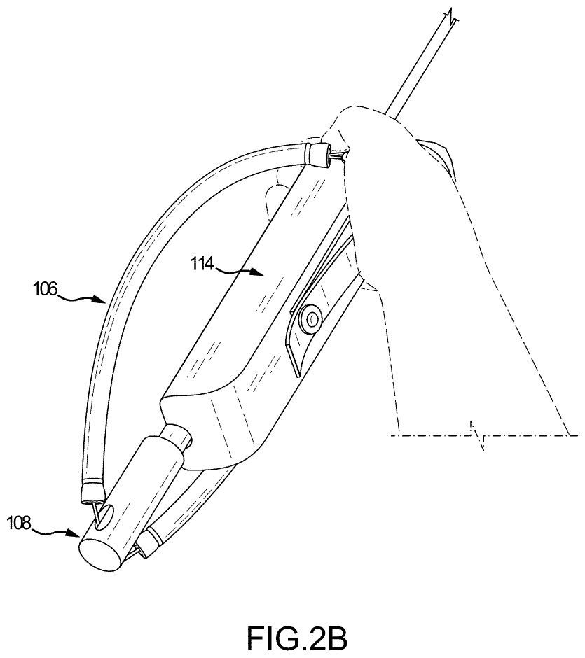

FIGS. 2A-2B illustrate an embodiment of a device 100 of the present disclosure in combination with a user's hand. As shown, a projectile 102 is provided in combination with the device 100. A portion of a user's hand is inserted through the strap 110 in a manner that further allows the user to grasp the muzzle 114 and/or the projectile 102. As will be recognized by one of ordinary skill in the art, various forces are applied to the device 100 during use. For example, in order to prepare the device for firing, force is applied to the receiving member 108 to translate it away from the muzzle. The elastic member 106 is stretched during this process and an equal and opposing force must be applied to the muzzle 114 to prevent the muzzle from translating with the receiving member 108 (i.e. to maintain the muzzle in a fixed position). During firing of the projectile 102, the receiving member 108 is released and the elastic member 106 applies a force to propel the projectile 102 forward. An opposing force must again be applied to the device 100 if the projectile is have its intended effect. These opposing forces are contemplated as being provided by the user, and specifically by a single hand grasping the device 100. The strap 110 is provided to assist the user in these operations and such that a user's grasping force on a wet or submerged object is not the only factor. The forward facing loop 100 is operable to wrap around the hand of a user (see FIG. 2A) and aid in loading the projectile 102 such that the muzzle 114 is generally prevented from translating backward with the receiving member 108 and/or projectile 102. Upon firing, the strap 110 further assist in maintaining a user's grasp on the device.

Furthermore, and as shown in FIG. 2A, the strap 110 of various embodiments of the present disclosure is advantageously positioned such that at least a portion of the device extends proximal to or beyond a distal end of the muzzle 114. A user's hand provided within the strap is thus capable of communicating with the strap 110, the muzzle 114, and a projectile 102 loaded in the muzzle 114. This allows for the user to contact and secure the projectile 102 at least when the projectile is loaded and cocked or prepared for firing. As noted, embodiments of the present disclosure comprise devices that preferably lack a locking member and/or trigger member. Thus, when the projectile and elastic member 106 are provided in their loaded state, a user-applied force is required to maintain this condition. This user-applied force is contemplated as comprising a grip force from the user's hand or finger(s) and wherein a firing of the projectile 102 is accomplished by an ergonomic and simple release of said user-applied force. Accordingly, the device 100 may be aimed at a target and firing of a projectile 102 is accomplished by simple release the projectile.

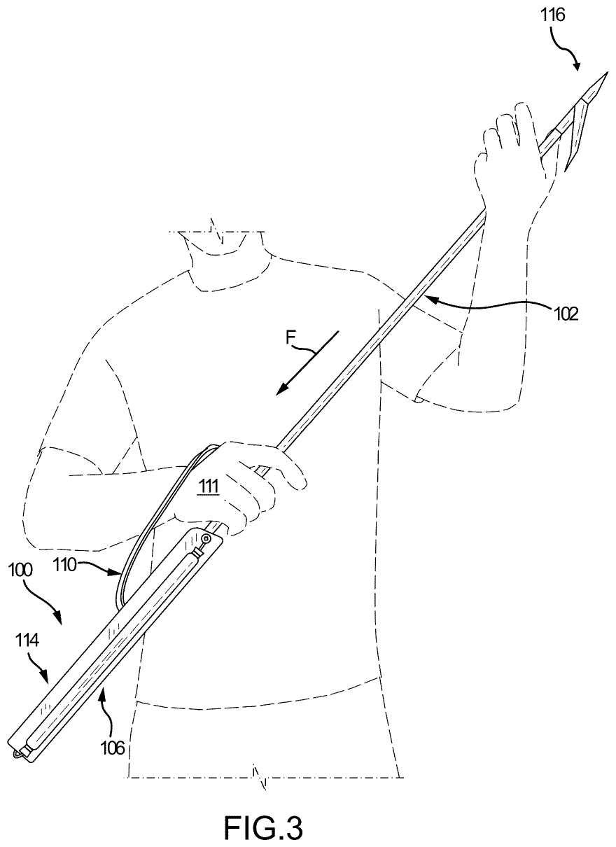

FIG. 3 illustrates an embodiment of the present disclosure wherein the device 100 is provided in communication with a user. As shown, a projectile 102 is provided. The projectile 102 is contemplated as comprising an elongate spear, but may comprise various projectiles as will be recognized by one of ordinary skill in the art. In various embodiments, the projectile 102 is contemplated as being fully detachable from the device 100. In other embodiments, the projectile 102 comprising a tether (e.g. line, spring, etc.) that secures the projectile 102 to the device 100 to enable tracking and recovery of the projectile 102 after it is launched or fired. The projectile 102 is shown in FIG. 3 as being partially inserted into the muzzle. The projectile is not fully loaded and the elastic member 106 is not extended or displaced in FIG. 3. In preferred embodiments, a force F is applied by the user to the projectile 102 to translate the projectile 102 into the muzzle 114 and extend the elastic member 106 into a loaded state wherein potential energy is provided within the elastic member 106. Once extended or loaded to the desired extent, a user's hand 111 is operable to maintain the projectile 102 in the fully loaded or “cocked” position by grasping at least one of the muzzle and the projectile 102 and providing a clamping force thereto. As shown, the strap 110 is provided and secured to the muzzle 114. The strap comprises a length of material formed into a loop or partial loop such that it is capable of extending distally beyond the distal end of the muzzle 114. As shown and as will be recognized by one of ordinary skill in the art, at least a portion of the force F required to fully load the projectile 102 is transferred to the muzzle 114 by the elastic member 106. In preferred embodiments, this force is resisted by a user grasping the muzzle 114 and causing the muzzle 114 to remain substantially stationary. Once the elastic member 106 is extended to its full or desired amount, the user can maintain the projectile 102 in this loaded and ready-to-fire state by grasping the projectile 102 and a distal end of the muzzle 114 with one hand 111. In such embodiments, the user may move about, aim, and fire the projectile 102 in a single-handed fashion. Firing of the projectile 102 is achieved by simply loosening or releasing the grip on the projectile.

Various embodiments of the present disclosure, including that shown in FIG. 3, contemplate one-handed operation and the provision of the strap 110 as shown. The strap 110 provides a user-interface and a means for stabilizing the muzzle 114 and the position of the muzzle 114 during loading. Additionally, the strap positions a user's hand such that the hand may readily and easily grasp and secure the projectile 102 in a desired position. As will be recognized, the provision of a similar device that lacks the strap 110 as shown and described would require two-handed operation as is known, for example, with existing devices known as Hawaiian slings. In such devices, one hand is generally required to hold the muzzle and a second hand is used to draw the projectile and elastic member proximally. That condition is maintained by holding the device with both hands until release of the projectile is desired, the user's grasp on the projectile is release and the projectile is fired. In contrast, embodiments of the present disclosure contemplate and enable one-handed operation and myriad associated benefits with respect to swimming, aiming, etc.

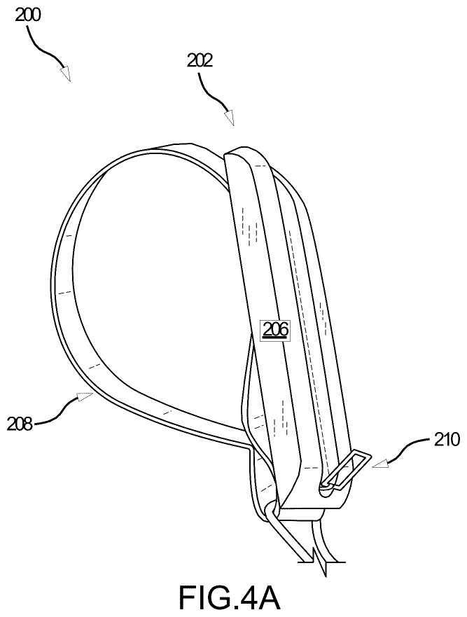

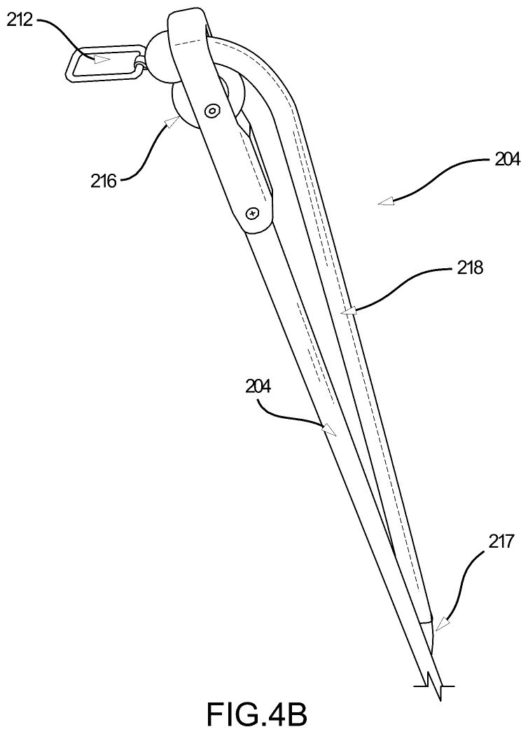

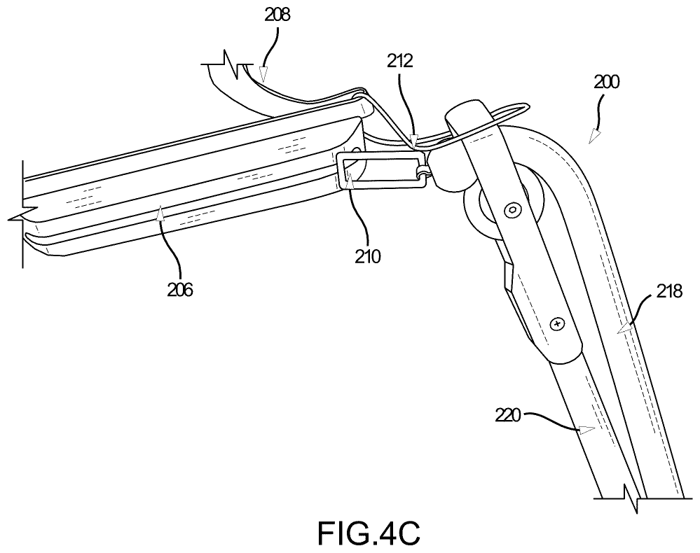

FIGS. 4A-4C depict an embodiment of a device 200 according to an embodiment of the present disclosure. As shown, the device 200 comprises a spear fishing or launching device comprising a shooter 202 that is operable for use with a projectile 204. The embodiment of FIGS. 4A-4C provide a fully detachable projectile 204. It is further contemplated, however, that the projectile 204 of various embodiments including but not limited to that of FIGS. 4A-4C may be tethered to the shooter by a line or similar means to facilitate recovery of the projectile.

The projectile 204 of FIGS. 4B-4C comprises a spear with an integrated elastic member 218 for storing energy and launching the projectile 204. More specifically, the projectile 204 comprises an elastic member 218 that is secured to the shaft 220 of the projectile at a first end 217. The elastic member is provided or wrapped around a pulley or guide member 216, and a second end comprises a bracket 212 for selective communication with a shooter 202. The embodiment of FIGS. 4A-4C provide a system with a detachable shooter 202 and wherein the shooter 202 comprises a handgrip 206 and a strap 208. The detachment of the shooter 202 with respect to the projectile 204 as will be shown and described provides a more hydrodynamic projectile upon firing and allows for greater shooting distance and accuracy. As shown, the shooter 202 comprises a handgrip 206 that can be sized and shaped in various arrangements. A strap 208 is secured to and extends from the handgrip 206. The shooter 206 further comprises a force-transmitting member 210. The force-transmitting member 210 comprises at least one of a tang, a pawl, a rigid extension, and a hook (for example) that extends from the handgrip 206. The force-transmitting member 210 is operable to communicate with a bracket 212 provided on the projectile. The bracket 212 is contemplated as comprising a substantially rigid hinged member that is operable to selectively communicate with the force-transmitting member 210. More specifically, the bracket 212 is contemplated as comprising an interface for the force-transmitting member 210 of the shooter 202. As shown, the bracket 212 is provided at a second end of the elastic member 218 and the elastic member 218 is operable be extended under force applied to the bracket 212. In preferred embodiments, the force is applied to the elastic member via the shooter 202 and force-transmitting member 210 when attached to the bracket 212. This extends the end of the elastic member 218 which can be translated along a length of the projectile 204 (along with the shooter). Tension may be secured by grasping the shooter 206, the strap 208, and the projectile 204. Tension may be released and firing of the projectile 204 accomplished by releasing the grasping force. Upon release, the hinged bracket 212 is freed from the force-transmitting member 210 and the shooter 202 whereupon the projectile is free to travel without the added weight and drag-force associated with the shooter 202.

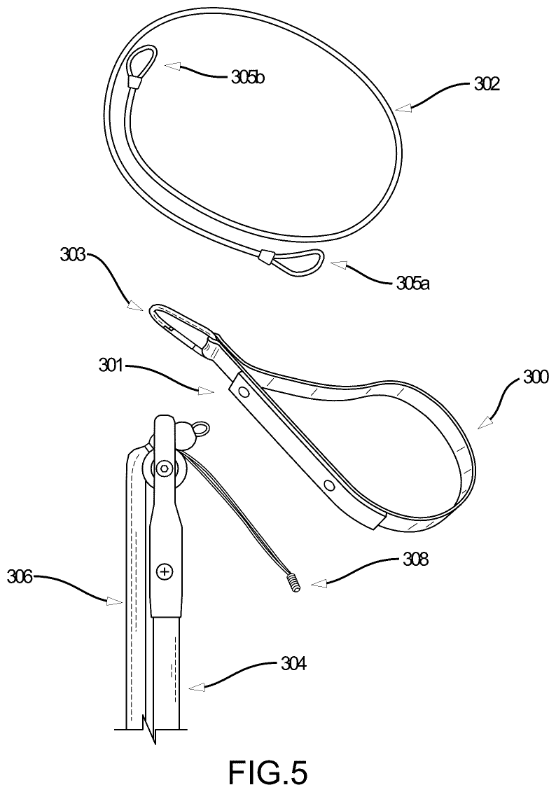

FIG. 5 is a view of a system according to an embodiment of the present disclosure. As shown, a detachable handle 300 is provided. The detachable handle 300 comprises a strap and is operable in at least two different modes as described below. In one mode, the handle 300 comprises a tang 301 that is provided in selective and detachable communication with an end 308 of an elastic member 306 associated with a projectile 304. The handle 300 and tang 301 assist in loading or extending the elastic member 306 and the user may grip the projectile 304 with the assistance of the handle 300. Upon firing, the tang 301 is allowed to detach from the projectile 304 which is then allowed to travel generally unencumbered by the handle. In a second mode, a tether 302 is provided that can be secured at one end 305a to the handle (via the carabiner 303, for example) and to the distal end 308 of the elastic member at the second end 305b. In the second mode, the handle does not detach upon firing and the tether 302 provides a connection between the handle 300 and the projectile 304 to assist in recovering the projectile, for example.

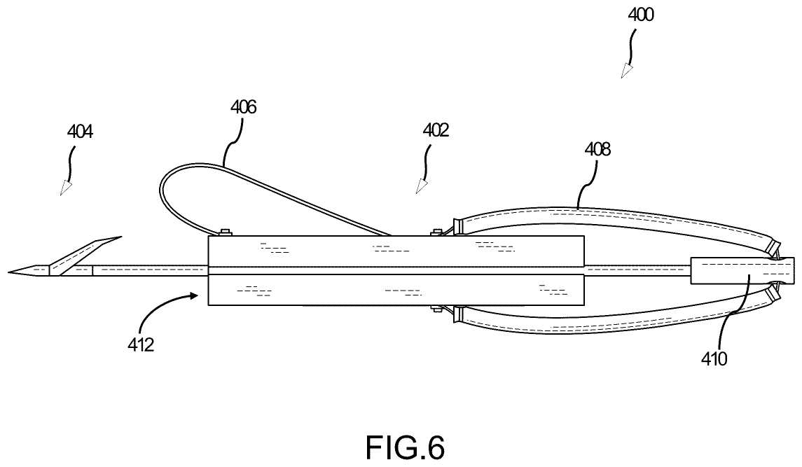

FIG. 6 is a view of another embodiment of the present disclosure wherein a spear fishing device 400 comprises a muzzle 402 or shooter, a spear 404 that can be loaded into and fired from the muzzle 402, a hand strap 406, and an elastic member or rubber band 408 with a cup 410 to store force and apply force to the spear 404 when desired. As shown, the hand strap 406 is sized and positioned such that it extends forwardly of the shooter or muzzle 402. The hand strap's 406 size and position enables a user to grasp a distal end 412 of the shooter 402 and/or the spear 404 to hold and maintain the spear 404 in a loaded, ready-to-fire position. A release of the user's grasp will allow the elastic member 408 to expel the spear 404 toward a target.

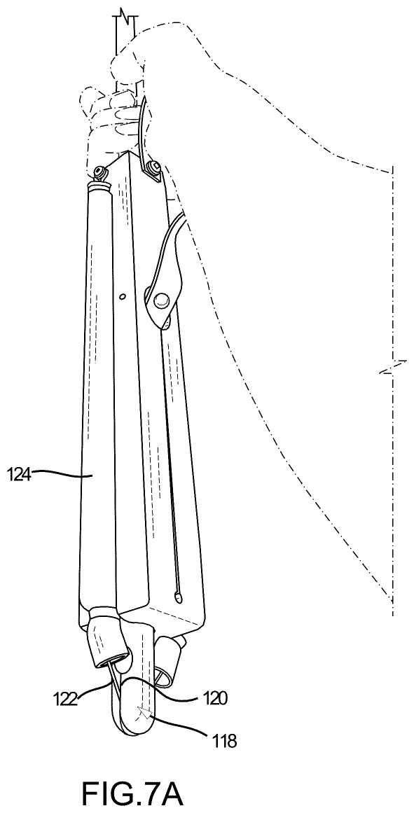

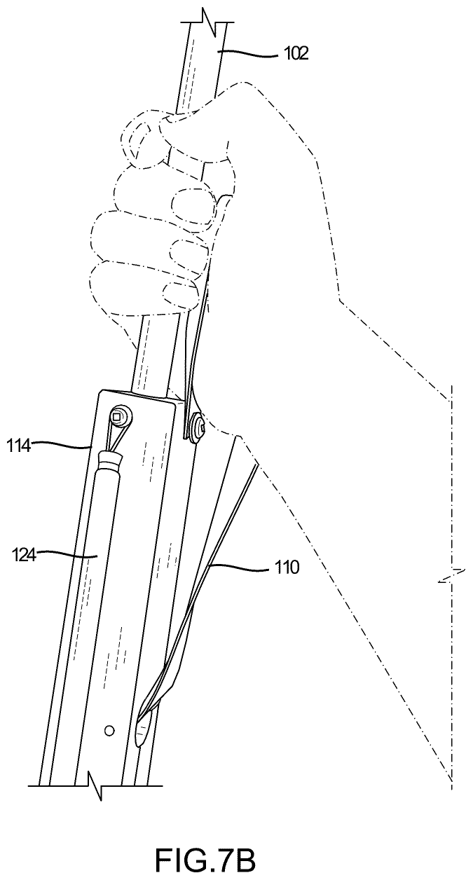

FIGS. 7A-7B are supplemental views of the system and embodiment of FIG. 3, for example. FIGS. 7A-7B are provided to illustrate the sizing, placement, and position of the strap 110 and one intended use with a user's hand. As shown, the user's hand is received by the strap 110, and the user's hand is allowed to be positioned forward of the muzzle 114 such that the project 102 can be grasped. The Force F (as shown in FIG. 3) may be provided by the user to the projectile 100 and the forward or distal end of the muzzle 114. In the non-limiting embodiments, as shown in FIGS. 7A-7B, the projectile 102 further comprises a first end 116, (as shown in FIG. 3) and a second end 118. For example, the first end comprises a pointed end constructed to pierce through a target, such as a fish, and the second end 118 comprises a blunt end with a seam 120. The seam 120 is constructed to receive the elastic member 106. Specifically, in the non-limiting embodiment, the elastic member 106 includes a string 122 and a tube 124 wrapping around at least a portion of the string 122, exposing the remaining portion proximate to the proximal end of the handle of the string 122 unwrapped. The seam 120 of the projectile is constructed to catch and receive the exposed portion of the string 122.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. It is to be understood that the phraseology and terminology used herein is for the purpose of description and should not be regarded as limiting.

It is to be appreciated that any feature described herein can be claimed in combination with any other feature(s) as described herein, regardless of whether the features come from the same described embodiment.

What is claimed is:

1. A handheld system for launching a projectile, the system comprising:
a substantially rigid handle portion operable for communication with a user;
a length of material formed into a loop and secured to the substantially rigid handle portion;
wherein the substantially rigid handle portion comprises a length extending between a distal end and a proximal end;
wherein the length of material is secured to the substantially rigid handle at at least one anchor point provided between the distal end and the proximal end, and the length of material extends from the at least one anchor point to a distance equal to or greater than a distance between the anchor point and the distal end of the substantially rigid handle portion.

2. The system of claim 1, further comprising an elongate spear operable to be deployed from the substantially rigid handle portion.

3. The system of claim 1, wherein the at least one anchor point comprises a single anchor point and wherein the length of material comprises a strap having a first end and a second end, and wherein the first end and the second end are secured to the single anchor point and the loop extends therefrom.

4. The system of claim 1, wherein the at least one anchor point comprises first and second spaced apart anchor points and wherein the length of material comprises a strap having a first end secured to the first anchor point and a second end secured to the second anchor point.

5. The system of claim 1, wherein an elastic member is connected to the substantially rigid handle portion and is operable to launch the projectile.

6. The system of claim 2, further comprising a tether connecting the elongate spear and the substantially rigid handle portion.

7. The system of claim 1, wherein the length of material comprises a flexible member.

8. The system of claim 2, wherein the elongate spear extends at least partially into the substantially rigid handle portion.

9. The system of claim 2, wherein the elongate spear comprises an elastic member for receiving a force and storing potential energy.

10. The system of claim 2, wherein the elongate spear comprises a rigid member for communicating with the substantially rigid handle portion.

11. The system of claim 10, wherein the rigid member comprises a hinged clip.

12. A handheld system for launching a projectile, the system comprising:
a handle portion operable for communication with a user, wherein the handle portion comprises a muzzle constructed to receive the projectile, and wherein the handle portion comprises a length extending between a distal end and a proximal end; and
a length of material formed into a loop and secured to the handle portion, wherein the loop is constructed to receive a hand of the user,
wherein the length of material is secured to the handle portion at least one anchor point provided between the distal end and the proximal end, and the length of material extends from the at least one anchor point to a distance equal to or greater than a distance between the anchor point and the distal end of the handle portion, and
wherein the hand of the user is allowed to be positioned forward of the muzzle such that the projectile can be grasped by the hand of the user.

13. The handheld system of claim 12, wherein an elastic member is connected to the handle portion and is operable to launch the projectile.

14. The handheld system of claim 13, wherein the elastic member comprises a receiving member constructed to receive an end of the projectile.

15. The handheld system of claim 12, wherein the handle portion comprises a slot along a bottom portion of the muzzle of the handle portion, wherein the slot is constructed to ease insertion and/or release of the projectile, and wherein the slot allows for expansion and contraction of the muzzle.

16. A handheld system for launching a projectile, the system comprising:
a handle portion, wherein the handle portion comprises
a muzzle;
a distal end and a proximal end opposite to the distal end; and
a slot extending between the distal end and the proximal end, wherein the slot is constructed to receive at least a portion of the projectile;
wherein the handle portion comprises a first anchor point proximate to the distal end, wherein the handle portion comprises a second anchor point opposite to the first anchor point and located between the distal end and the proximal end;
a length of material, the length of material comprising a first end secured to the first anchor point and a second end secured to the second anchor point, wherein, when secured to the handle portion, the length of material forming a first loop constructed to receive a hand of the user, and wherein the hand of the user is allowed to be positioned forward of the muzzle such that at least a portion of the loop extends over the distal end; and
an elastic member, wherein the elastic member is connected to the handle portion and operable to launch the projectile.

17. The handheld system of claim 16, wherein the projectile comprises a first end and a second end, wherein the first end of the projectile comprises a pointed end, and wherein the second end of the projectile comprises a blunt end, the blunt end comprising a seam constructed to receive the elastic member.

18. The handheld system of claim 17, wherein the elastic member comprises a string and at least one tube, wherein the tube wraps around at least a portion of the string and exposes remaining portion of the string proximate to the proximal end of the handle portion unwrapped, and wherein the seam of the projectile receives the unwrapped portion of the string.

19. The handheld system of claim 16, wherein the elastic member forms a second loop extending over the proximal end of the handle portion.

20. The handheld system of claim 16, wherein the length of material is constructed with a flexible material.
